(19) United States
(12) Patent Application Publication
(10) Pub. No.: US 2002/0054409 A1
(43) Pub. Date: May 9, 2002

(54) Fiber optic transceiver employing clock and data phase aligner

(76) Inventors: Meir Bartur, Los Angeles, CA (US); Jim Stephenson, Thousand Oaks, CA (US)

Correspondence Address: David L. Henty, Myers, Dawes & Andras LLP, 19900 MacArthur Blvd., Suite 1150, Irvine, CA, 92612, US

(21) Appl. No.: 09/907,057

(22) Filed: Jul. 17, 2001

Related U.S. Application Data
(60) Provisional application No. 60/230,571, filed on Sep. 5, 2000.

(51) Int. Cl. H04B 10/00; H04B 10/06

(52) U.S. Cl. 359/152; 359/189

(57) ABSTRACT

An optical transceiver adapted for use in an optical fiber data transmission system which is capable of efficiently detecting burst mode data transmission from multiple transmitters despite phase differences between data bursts is disclosed. The transceiver operating in a receive mode employs a front end which receives modulated light signals and converts the signals to modulated electrical signals and provides a digital signal. A back end, coupled to the front end, receives the digital signal and a clock signal and outputs data derived from the digital signal and phase aligned to the clock. The back end comprises a clock and data phase aligning circuit which derives plural phase shifted digital signals from the input digital signal and selects one of the phase shifted digital signals as an output. This provides output data which is phase aligned to the clock. High speed phase alignment is provided allowing accurate phase alignment on a burst to burst basis.

### RELATED APPLICATION INFORMATION

The present application claims priority under 35 USC 119 (e) of provisional application Ser. No. 60/230,571 filed Sep. 5, 2000 the disclosure of which is incorporated herein by reference.

### BACKGROUND OF THE INVENTION

1. Field of the Invention

The present invention relates to fiber optic transmitters and receivers and related optical networking systems and methods of transmitting and receiving data along optical networking systems.

2. Background of the Prior Art and Related Information

Fiber optic data distribution networks are becoming increasingly important for the provision of high bandwidth data links to commercial and residential locations. Such systems employ optical data transmitters and receivers (or “transceivers”) throughout the fiber optic distribution network. Depending on the specific implementation of the fiber optic network the optical transceivers may operate in a continuous mode or in a burst mode. Also, depending on the specific architecture of the fiber optic network a given receiver may be coupled to receive data from one or a relatively large number of individual transmitters. Referring to FIGS. 1A and 1B, typical continuous mode and burst mode data transmission patterns are illustrated, respectively. As illustrated in FIG. 1A, in a typical continuous mode data transmission pattern the modulated optical power levels correspond to the encoded data. For example, NRZ (Non Return to Zero) encoding is common in fiber optic distribution networks. In the example of FIG. 1, a high optical power level corresponds to a “1” while a low optical power level corresponds to a “0”, as illustrated in the diagram. Various other encoding techniques may be employed, however, as will be appreciated by those skilled in the art. In any case, in continuous mode transmission the power level corresponding to a high signal will be relatively constant, or at least relatively slowly varying, over time. This allows the receiver to lock onto the optical power levels corresponding to the high and low signals and allows the receiver to relatively easily discriminate the encoded data from the modulated light pulses. Continuous mode transmission may typically be employed where a fiber is not shared by two transmitters or where wavelength division multiplexing is employed to share a fiber.

In FIG. 1B, a representative burst mode data pattern is illustrated corresponding to first and second data bursts provided from the transmitter of a single transceiver. As illustrated a typical data burst or packet comprises a relatively short, high density burst of data. Each burst is typically followed by a relatively long period during which the transmitter is asleep, before the next data burst. During this sleep period another transmitter may be active on the same fiber. Such burst transmission may thus allow multiple transceivers to share an optical fiber on a time division multiple access (TDMA) basis. Also, such burst transmission may allow one receiver to be coupled to receive data from many transmitters on a time multiplexed basis, whether by sharing of a fiber or with separate fibers. For example, burst transmission may be employed in fiber optic data distribution networks which couple a central data distribution transceiver to multiple end user transceivers on a TDMA basis. Also, continuous and burst transmission may be combined in some fiber optic data distribution networks. For example, a central data distribution transceiver may transmit in a continuous mode, e.g., a cable TV signal, whereas the end user transceivers transmit in a burst mode back to the central data distribution transceiver.

Although the use of burst mode transmission, and the combination of burst and continuous mode transmission, has advantages in fiber optic data distribution networks such transmission modes can create problems in data recovery and system costs. One potential problem in data recovery arises in fiber optic networks which employ a local system clock at the receiver location and multiple transmitters transmitting data based on the same clock. Such synchronous systems are typically employed for networks using burst transmission, such as passive optical networks. Although all the received data will have the same frequency, phase shifts between the clock in the receiver and the received data may occur. These phase shifts can cause errors in data recovery. Although the receiver could lock the two phases together over time using a phase locked loop (PLL) this is impossible in high data density burst transmission systems. This is the case since consecutive bursts may be spaced only a few bit timings apart and will in general be provided from different transmitters in different transceivers and the phase of the data in the two bursts may differ significantly. For example, one transmitter may be significantly farther from the receiver than the other transmitter resulting in phase differences at the receiver. Also, the optical signals from different transmitters may have phase differences introduced at nodes of passive optical splitters. Other varying factors in the optical paths from the two transmitters to the receiver may also affect the phase. Therefore, a PLL system could not adjust quickly enough to the phases of consecutive data bursts to ensure accurate clock and data phase alignment.

Therefore, undesirably high data errors may result when a single receiver is coupled to multiple transmitters operating in burst mode transmission.

It will be appreciated from the foregoing that the recovery of data in burst transmission systems places significantly greater demands on the receiver than continuous mode transmission system. Nonetheless, in order to provide flexibility in implementing a given fiber optic network using the minimum number of individual electronic comments, it may be desirable to have a receiver capable of operating to detect both continuous mode data transmission and burst mode data transmission. Also, it may be desirable to provide such different modes of operation at a single point in an optical fiber data transmission system but at different times. Therefore, such flexibility provides additional constraints on the ability of the receiver to operate to consistently detect data. Also, it is extremely important to provide these capabilities without significantly increasing the costs of the system.

Accordingly, it will be appreciated that a need presently exists for an optical receiver and/or transceiver capable of efficiently detecting burst mode data transmission from multiple transmitters despite phase differences between data bursts. It will further be appreciated that a need presently exists for such an optical receiver or transceiver which can provide such efficient data detection without added cost or complexity. It will further be appreciated that a need presently exists for an optical receiver or transceiver capable of operating in both burst and continuous mode.

### SUMMARY OF THE INVENTION

The present invention provides an optical receiver and/or transceiver adapted for use in an optical fiber data transmission system which is capable of efficiently detecting burst mode data transmission from multiple transmitters despite phase differences between data bursts. The present invention further provides an optical receiver or transceiver which can provide such efficient data detection without added cost or complexity. The present invention further provides an optical receiver or transceiver capable of operating in both burst and continuous mode.

In a first aspect the present invention provides an optical receiver. The optical receiver comprises a photo-detector for receiving an input modulated light beam and providing as an output a modulated electrical signal. A receiver front end is coupled to the photo-detector output and provides a digital signal from the modulated electrical signal. A receiver back end is coupled to the front end and receives the digital signal and an externally provided clock signal and employs clock and data phase aligning circuitry to provide a digital signal phase aligned with the clock. The clock and data phase aligning circuitry comprises a data delay circuit which receives the digital signal and delays it to provide plural phase shifted digital signals. The back end clock and data phase aligning circuitry further comprises a selection circuit which selects one of the plural phase shifted digital signals for use as the phase aligned digital signal. Preferably, a latch clocked by the clock signal receives the phase aligned digital signal and outputs a clock synchronized output.

In a first implementation, the clock and data phase aligning circuit further comprises a clock delay circuit receiving the clock signal and delaying the clock signal to provide plural delayed clock signals. A clock delay latch is coupled to the clock delay circuit and receives the plural delayed clock signals and the input digital signal. The clock delay latch latches the plural delayed clock signals in response to the digital signal, for example, on the rising edge or falling edge of the digital signal. Alternatively, by employing a second clock delay latch and a latch multiplexer both the rising and falling edge of the digital signal may be used. The selection circuit preferably comprises a multiplexer, coupled to the clock delay latch circuit (or the latch multiplexer) and the data delay circuit, which selects one of the phase shifted digital signals. An enable input to the clock delay latch(es) allows the phase relationship to be maintained, e.g., for the duration of a data packet.

In another implementation, the clock and data phase aligning circuit need not employ a clock delay circuit or clock delay latch. In such an implementation the clock and data phase aligning circuit further comprises a data delay latch receiving the plural phase shifted digital signals and the clock signal. The data delay latch latches the phase shifted digital signals in response to the clock signal. A control logic circuit is coupled to the output of the data delay latch and provides a control signal to the selection circuit based on the data delay latch output.

In a further implementation, suitable for use in systems where the data has a known reference pattern, the receiver employs a data recognition circuit for comparing the plural delayed digital signals to the reference data pattern and providing plural comparison signals. A control logic circuit is coupled to the data recognition circuit and provides a control signal based on the plural comparison signals. A selection circuit selects one of the plural delayed digital signals in response to the control signal.

In a further aspect the present invention provides a synchronous burst mode optical data transmission system comprising a plurality of transmitters providing burst mode modulated optical signals, at least one optical fiber optically coupled to the transmitters, and a receiver optically coupled to the fiber and receiving the burst mode modulated optical signals. The receiver comprises means for receiving the modulated light from the optical fiber at the receive location, means for converting the received modulated light to a digital electrical signal, means for aligning the phase of the digital signal to the phase of a clock signal on a burst to burst basis, and means for providing a clock aligned digital signal as an output.

In yet another aspect the present invention provides a method for transmitting data between transmit and receive locations over an optical network in a burst mode. The method comprises providing modulated light to an optical fiber at the transmit location in bursts, the bursts comprising a plurality of data bits. The modulated light is received from the optical fiber at the receive location and converted to a digital electrical signal. The phase of the digital signal is aligned to the phase of a local clock signal on a burst to burst basis and a clock aligned digital signal is provided as an output.

The above described embodiments of the present invention provide a number of advantageous features. In particular, phase alignment is provided very rapidly, for example, within three clock cycles, allowing accurate phase alignment on a burst to burst basis. Also, the ability to remember phase relationship and maintain using the enable control is advantageously provided. Also, the ability to operate from DC to GHz range is provided. Further features and advantages will be appreciated from a review of the following detailed description of the invention.

### BRIEF DESCRIPTION OF THE DRAWINGS

FIGS. 1A and 1B are optical power vs. timing diagrams illustrating typical continuous and burst mode data transmission waveforms.

FIG. 2 is a block schematic drawing of a dual fiber fiber optic data transmission system in accordance with the present invention.

FIG. 3 is a block schematic drawing of a single fiber fiber optic data transmission system in accordance with the present invention.

FIG. 4 is a block schematic drawing of a transceiver coupled to dual optical fibers in accordance with the present invention.

FIG. 5 is a block schematic drawing of a transceiver coupled to a single optical fiber in accordance with the present invention.

FIG. 6 is a block schematic drawing of an optical receiver back end employing a clock and data phase aligning circuit in accordance with the present invention.

FIG. 7 is a block schematic drawing of an optical receiver back end employing an alternate embodiment of the clock and data phase aligning circuit in accordance with the present invention.

FIG. 8 is a block schematic drawing of an optical receiver back end employing another alternate embodiment of the clock and data phase aligning circuit in accordance with the present invention.

FIG. 9 is a timing diagram illustrating the operation of the clock and data phase aligning circuit of FIG. 6.

FIG. 10 is a timing diagram illustrating the operation of the clock and data phase aligning circuit of FIG. 8.

FIG. 11 is a block schematic drawing of an optical receiver back end employing a data recognition circuit in accordance with the present invention.

FIG. 12 is a block schematic drawing of the data recognition circuit employed in a optical receiver back end of FIG. 11 in accordance with the present invention.

### DETAILED DESCRIPTION OF THE INVENTION

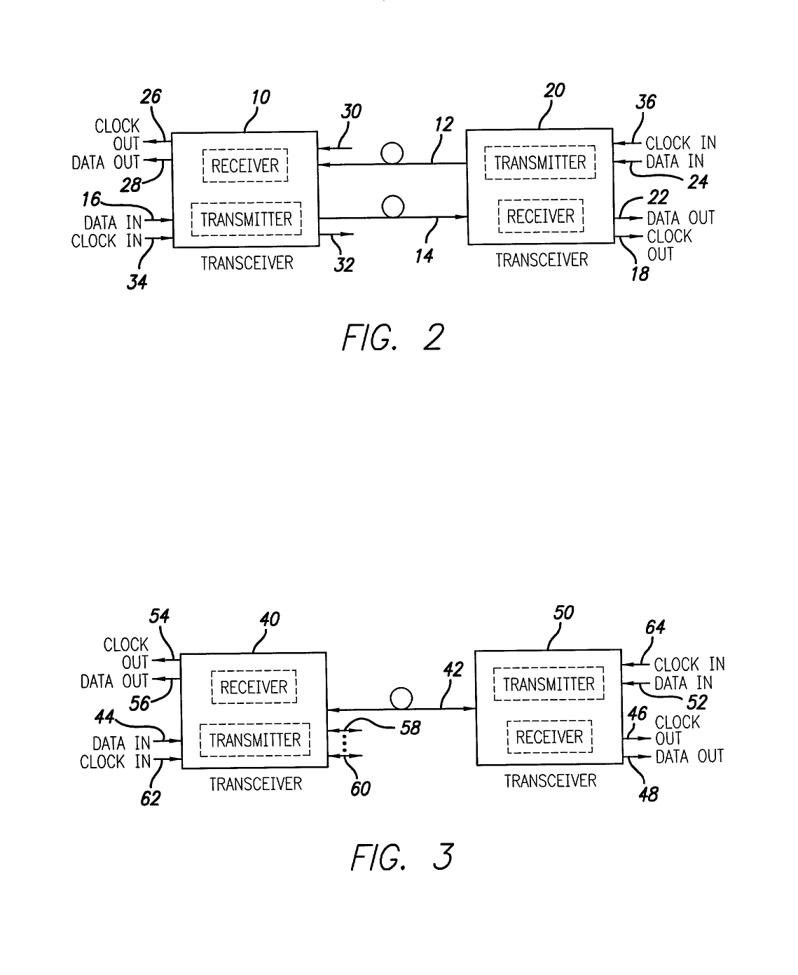

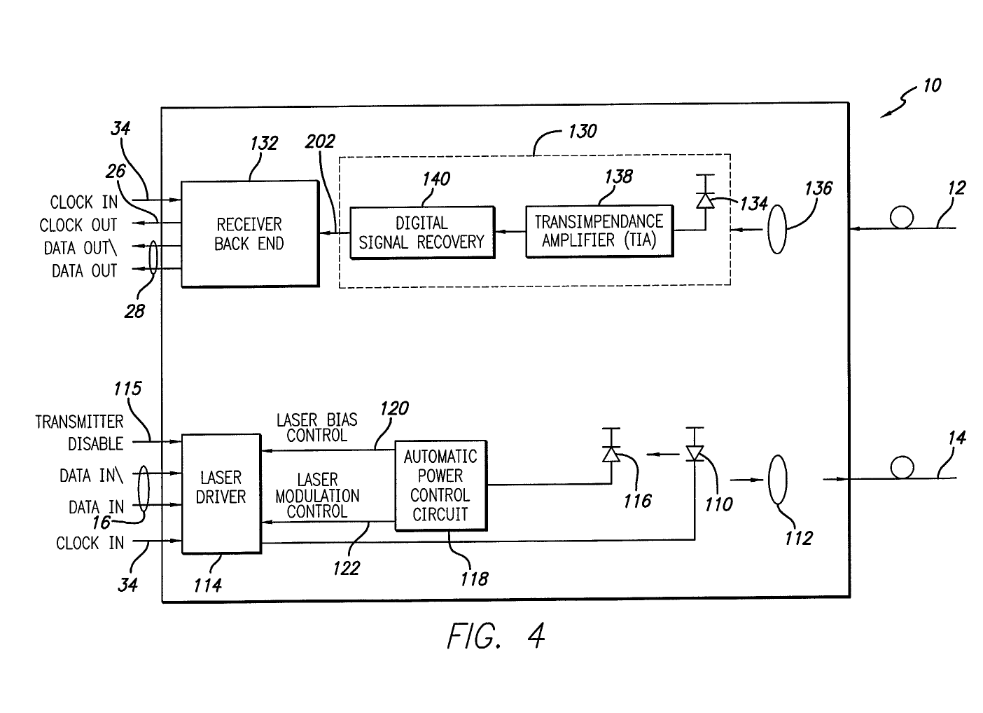

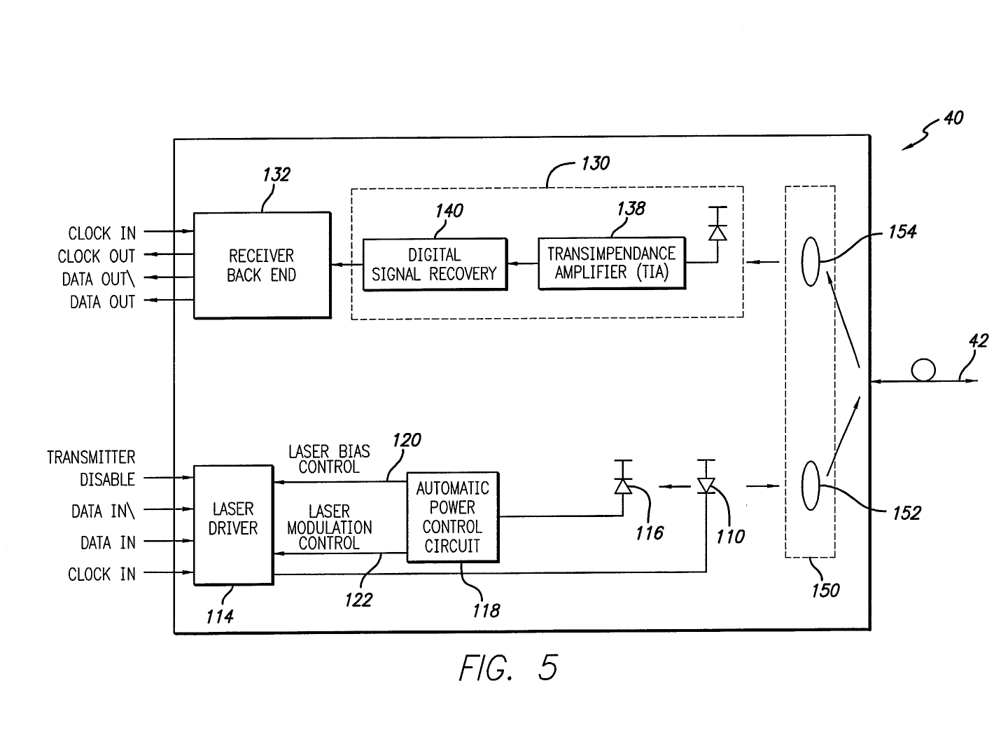

Referring to FIGS. 2 and 3, a high-level block schematic drawing of a fiber optic data transmission system incorporating the present invention is illustrated. FIG. 2 corresponds to a dual fiber data transmission system while FIG. 3 corresponds to a single fiber data transmission system.

Referring first to FIG. 2, a first transceiver 10 is coupled to a second transceiver 20 via first and second optical fibers 12 and 14. As indicated by the arrows on the optical fibers, transceiver 10 transmits data to transceiver 20 in the form of modulated optical light signals along optical fiber 14. The data to be transmitted may be provided to transceiver 10 from an external data source in the form of input electrical data signals along line 16. Transceiver 20 in turn converts the modulated light signals provided along fiber 14 to electrical signals and provides clock and data signals along lines 18 and 22 as illustrated in FIG. 2. Transceiver 20 also receives as an input electrical data signals along line 24 and transmits the data along fiber 12 in the form of modulated light signals to transceiver 10. Transceiver 10 converts the received modulated light signals to electrical signals and provides output clock and data signals along lines 26 and 28, as illustrated. In synchronous systems transceivers 10 and 20 will receive a clock signal along lines 34 and 36, respectively, in which case a clock output along lines 18 and 28 is not necessary.

Both transceiver 10 and transceiver 20 include receiver circuitry to convert optical signals provided along the optical fibers to electrical signals and to detect encoded data and/or clock signals. In various applications data transmission along the optical fibers may be in burst mode or both burst and continuous modes at different times. Also, one fiber may carry data transmitted in burst mode and another in continuous mode. For example, transceiver 10 may transmit data along fiber 14 in a continuous mode whereas transceiver 20 may transmit data back to transceiver 10 along fiber 12 in a burst mode. This configuration may for example be employed in a passive optical network (PON) where transceiver 10 corresponds to an optical line terminator (OLT) whereas transceiver 20 corresponds to an optical networking unit (ONU). In this type of fiber optic data distribution network transceiver 10 may be coupled to multiple optical networking units and this is schematically illustrated by fibers 30 and 32 in FIG. 2. For a PON system, the fibers are combined external to the transceiver. The number of such connections is of course not limited to those illustrated and transceiver 10 could be coupled to a large number of separate optical networking units in a given application, and such multiple connections are implied herein. As will be better appreciated from the following discussion, the present invention provides the capability to detect data transmitted in either burst or continuous mode operation in these various fiber optic network applications.

Referring to FIG. 3, a fiber optic transmission system is illustrated employing a single fiber coupling between transceivers 40 and 50. The operation of the transceivers in FIG. 3 is similar to that described in relation to FIG. 2 with the difference that a bidirectional data transmission is provided along fiber 42. For example, wavelength division multiplexing may be employed. Bidirectional transmission using a single wavelength of light may also be provided. If wavelength division multiplexing is employed transceiver 40 may provide data transmission to transceiver 50 employing a first wavelength of light modulated and transmitted along fiber 42 and transceiver 50 may provide data along fiber 42 to transceiver 40 employing a second wavelength of light. Alternatively transmission in the two directions may be provided in accordance with time division multiplexing or using other protocols. Input electrical data signals may be provided along line 44 from outside data source to transceiver 40 for transmission to transceiver 50 as modulated light signals. Transceiver 50 in turn receives the light pulses, converts them to electrical signals and outputs clock and data signals along lines 46 and 48 respectively. Transceiver 50 similarly receives input electrical data signals along line 52, converts them to modulated light signals and provides the modulated light signals along fiber 42 to transceiver 40. Transceiver 40 receives the modulated light pulses, converts them to electrical signals and derives clock and data signals which are output along lines 54 and 56, respectively. Also, clock inputs along lines 62 and 64 may be provided in a synchronous system. As in the case of the previously described embodiment of FIG. 2, the present invention provides the capability for either burst or continuous mode operation or both at different times. Also, as in the embodiment described above, one or more of transceivers 40 and 50 may be coupled to a plurality of additional transceivers and receive or transmit data to such transceivers along additional fibers 58 and 60, as illustrated in FIG. 3. It will further be appreciated that additional fiber coupling to additional transceivers may also be provided for various applications and architectures and such are implied herein.

Referring to FIG. 4, a block schematic drawing of a transceiver coupled to dual optical fibers in accordance with the present invention is illustrated. The transceiver illustrated in FIG. 4 may correspond to either transceiver 10 or 20 illustrated in FIG. 2 although it is denoted by reference numeral 10 in FIG. 4 and in the following discussion for convenience of reference. The transmitter portion of transceiver 10 may operate in a continuous mode, for example, in an application where the transceiver is an OLT in a fiber optic network. Alternatively, the transmitter may operate in a burst mode, for example, if transceiver 10 is an ONU in a PON fiber optic network. Also, the transmitter may have the capability to operate in both burst and continuous modes at different times. As illustrated, the transmitter portion of transceiver 10 includes a laser diode 110 which is coupled to transmit light into optical fiber 14 via passive optical components illustrated by lens 112 in FIG. 4. Passive optical components in addition to lens 112 may also be employed as will be appreciated by those skilled in the art. Laser diode 110 is coupled to laser driver 114 which drives the laser diode in response to the data input provided along lines 16 to provide the modulated light output from laser diode 110. Various modulation schemes may be employed, for example, NRZ encoding such as described above may be employed as well as other schemes well known in the art. In addition to receiving the data provided along lines 16 the laser driver 114 may receive a transmitter disable input along line 115 as illustrated in FIG. 4. This may be used to provide a windowing action to the laser driver signals provided to the laser diode to provide a burst transmission capability in a transmitter adapted for continuous mode operation to thereby provide dual mode operation. The laser driver 114 may also receive a clock input along line 34 which may be used to reduce jitter in some applications. As further illustrated in FIG. 4, a back facet monitor photodiode 116 is preferably provided to monitor the output power of laser diode 110. The laser output power signal from back facet monitor photodiode 116 is provided to an automatic power control circuit 1 18 which adjusts a laser bias control input to the laser driver 114 and a laser modulation control input to the laser driver 114, along lines 120 and 122 respectively. Suitable automatic power control circuits are disclosed in copending U.S. patent applications entitled “Fiber Optic Transceiver Employing Analog Dual Loop Compensation” to Meir Bartur, Farzad Ghadooshahy, Sean Zargari, and Jim Stephenson, and “Fiber Optic Transceiver Employing Digital Dual Loop Compensation” to Jim Stephenson, filed concurrently herewith, the disclosures of which are incorporated herein by reference. These control signals allow the laser driver 114 to respond to variations in laser diode output power, which power variations may be caused by temperature variations, aging of the device circuitry or other external or internal factors.

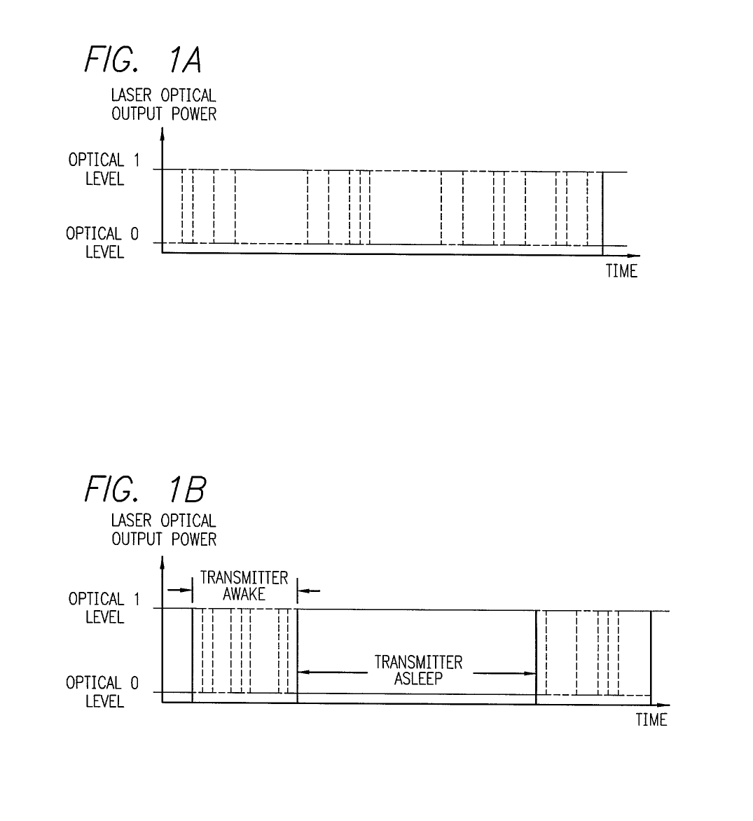

Still referring to FIG. 4, the receiver portion of the transceiver 10 includes a front end 130 and a back end 132. Front end 130 includes a photodetector 134, which may be a photodiode, optically coupled to receive the modulated light from fiber 12. Photodiode 134 may be optically coupled to the fiber 12 via passive optics illustrated by lens 136. Passive optical components in addition to lens 136 may also be employed as will be appreciated by those skilled in the art. The front end 130 of the receiver further includes a transimpedance amplifier 138 that converts the photocurrent provided from the photodiode 134 into an electrical voltage signal. The electrical voltage signal from transimpedance amplifier 138 is provided to digital signal recovery circuit 140 which converts the electrical signals into digital signals. That is, the voltage signals input to the digital signal recovery circuit from transimpedance amplifier 138 are essentially analog signals which approximate a digital waveform but include noise and amplitude variations from a variety of causes. The digital signal recovery circuit 140 detects the digital waveform within this analog signal and outputs a well defined digital waveform, for example, with a shape such as illustrated in FIG. 1A or 1B. A suitable digital signal recovery circuit is disclosed in co-pending U.S. patent application entitled “Fiber Optic Transceiver Employing Front End Level Control”, to Meir Bartur and Farzad Ghadooshahy, filed concurrently herewith. The digital signals output from digital signal recovery circuit 140 are provided to the back end of the receiver 132 along line 202. The receiver back end 132 removes signal jitter, for example using a latch and clock signal to remove timing uncertainties, and which may also derive the clock signal from the digital signal if a clock signal is not available locally. In the latter case the receiver back end 132 comprises a clock and data recovery circuit which generates a clock signal from the transitions in the digital signal provided from digital signal recovery circuit 140, for example, using a phase locked loop (PLL), and provides in phase differential clock and data signals at the output of transceiver along lines 26 and 28, respectively. An example of a commercially available clock and data recovery circuit is the AD807 CDR from Analog Devices. Also, the receiver back end 132 may decode the data from the digital high and low values if the data is encoded. For example, if the digital signal input to the clock and data recovery circuit is in NRZ format, the clock and data recovery circuit will derive both the clock and data signals from the transitions in the digital waveform. Other data encoding schemes are well known in the art will involve corresponding data and clock recovery schemes. In the case of synchronous systems, such as PON optical networks, the clock is available locally and the back end 132 aligns the phase of the incoming signal to the local clock, such that signals arriving from different transmitters and having differing phases are all aligned to the same clock. In this case the clock signals are inputs to the receiver from the local clock provided along line 34. A suitable clock and data phase aligner for such a synchronous application is described below.

Referring to FIG. 5, transceiver 40 is illustrated corresponding to a single fiber implementation such as discussed above in relation to FIG. 3. The single fiber transceiver 40 includes the same general functional elements as described in relation to transceiver 10 above and like numerals are employed. The single fiber embodiment of FIG. 5 differs from the embodiment of FIG. 4 in that it employs optics 150 adapted to deliver modulated light to fiber 42 from the transmitter portion of transceiver 40 and to provide incoming modulated light from fiber 42 to the receiver portion. The optics 150 is generally illustrated schematically in FIG. 5 by first and second lenses 152, 154, however, optics 150 may include filters and beams splitters to separate the wavelengths of light corresponding to the transmit and receive directions in a wavelength division multiplexing implementation of the single fiber transceiver. In a time division multiple access implementation of the single fiber transceiver employing a single wavelength of light, optics 150 may simply include the lenses or other optics to optically couple both the transmit laser diode and the receive photodiode to fiber 42.

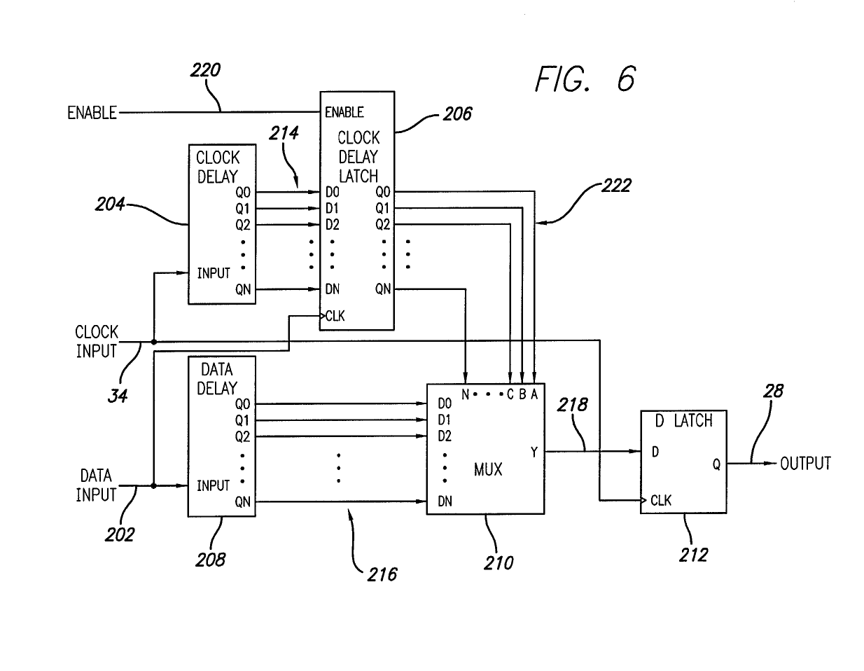

Referring to FIG. 6, a block schematic drawing of a preferred embodiment of back end 132 of the receiver portion of the transceiver of the present invention is illustrated. As discussed previously, the present invention provides the capability to receive input modulated light signals which transmit data in burst mode, continuous mode, or both burst and continuous mode of operation. The back end 132 functions as a clock and data phase aligner circuit and adjusts the phase of the serial input data provided from receiver front end 130 (shown in FIGS. 4 and 5) with reference to the local system clock so the output data is synchronized to the clock. The circuit solves the problem discussed above in the Background Section where the received data is the same frequency as the clock but may have a different phase than the clock. Also, the illustrated circuit can adjust the data phase to the local clock on a burst to burst basis, even where bursts are separated by a single bit timing. Accordingly, the back end of FIG. 6 may advantageously be employed in transceivers in a synchronous burst mode fiber optic network, such as a PON.

As shown in FIG. 6, the clock and data phase aligner circuit receives a Clock Input and Data Input along lines 34 and 202 respectively. The clock signal provided on line 34 is generated locally at the receiver location in the fiber optic network and is provided as an input to the receiver. The data on line 202 is provided from the receiver front end 130 as described previously. Clock Delay Circuit 204 receives the Clock Input and delays the Clock Input through a number of discrete steps (taps); preferably by 3 or more discrete steps. Each tap k has a delay Qₖ that is longer than the previous tap to provide a staggered sequence of delayed clock signals. For example, Q₀<Q₁<Q₂ . . . <Qₙ where Qₙ is preferably greater than the Clock Input period. More specifically, the differential delay between Q₀ and Qₙ is preferably greater or equal to (one clock period) * (n−1)/n. The value of the phase difference between Qₙ₋₁ and Qₙ, are preferably equal or similar to each other in magnitude (nominally the delay increment). Therefore, generally Qₖ=k * (delay increment), for k=0 to n. The plural delayed clock signals are output from Clock Delay Circuit 204 along lines 214 as illustrated.

The Clock Delay Latch 206 receives the delayed clock signals Q₀-Q_{N} from the Clock Delay Circuit 204 and the Data Input along line 202 to a clock input and provides an output which is a measure of the phase relationship between the Data Input and Clock Input. More specifically, the rising edge of the Data Input latches the output from of the Clock Delay Circuit 204 into the Clock Delay Latch 206 (Q₀-Qₙ). The Clock Delay Latch 206 output represents the phase relationship between the clock and data. The Clock Delay Latch 206 remembers the phase relationship between the Clock Input and Data Input. For example, the Clock Delay Latch 206 may comprise a number of D Latches. More specifically, (n+1) D Latches may be employed, one for each Q output from the Clock Delay Circuit 204. The Clock Delay Latch also has an enable input to allow control of the operation of the clock and data aligner circuit. The enable control line on the Clock Delay Latch 206 allows the system to remember the phase setting. For example, with packetized data, one may want to measure the phase during a preamble time and fix the phase during the data time.

The Data Delay Circuit 208 receives the Data Input along line 202 and delays the Data Input through a number of discrete steps (taps); preferably, by 3 or more discrete steps. Each tap has a delay that is longer than the previous tap to create a staggered output. The number of steps is preferably equal to or smaller than that of the Clock Delay Circuit 204. Therefore, for example, Data Delay Circuit 208 could be the same as the Clock Delay Circuit 204.

The delayed clock signals and delayed data signals are provided along lines 222 and 216, respectively, to Multiplexer (MUX) 210. Multiplexer 210 provides the logic to select the Data Delay Circuit 208 output (Qₒ-Qₙ) to use based on the output of the Clock Delay Latch 206. The Multiplexer 210 logic is designed to compensate for the delays in the logic and the phase relationship between the clock and data. The Multiplexer 210 connects one of the outputs from the Data Delay Circuit 208 to the data latch (D Latch) 212. The output connected is based on the value of the Clock Delay Latch 206 and the delay of the rest of the circuits. The output of the multiplexer 210 (Y) is applied to the D Latch 212 along line 218.

The data latch (D Latch) 212 synchronizes the data from the output of the Multiplexer 210 to the Clock Input and provides the synchronized data on line 28. The D Latch 212 uses the Clock Input to latch the data output from the Multiplexer 210 so that the output stream is always synchronized to the clock input. The enable input on line 220 allows the phase of the output from D latch 212 to be locked to the measured value by preventing Clock Delay Latch 206 from changing.

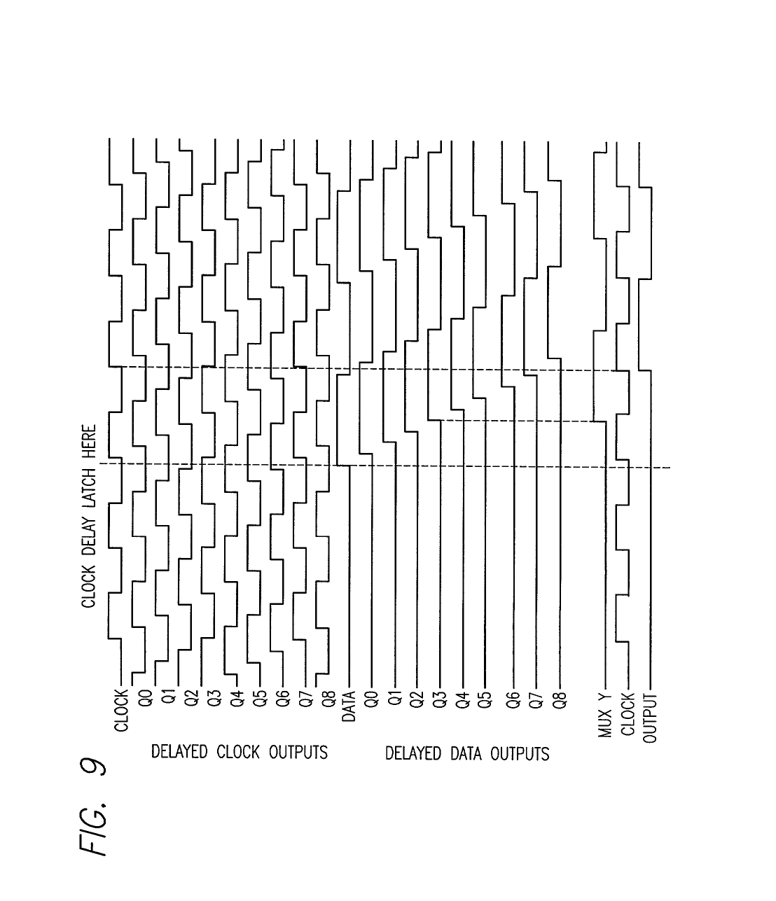

The circuit of FIG. 6 is next described for a specific timing example shown in FIG. 9. The timing diagram of FIG. 9 assumes N is equal to 8. The clock signal and the outputs from the Clock Delay Circuit 204 are shown. Also the data and outputs from the Data Delay Circuit 208 are shown. On the raising edge of the data, the value from the Clock Delay Circuit 204 is latched by the Clock Delay Latch 206. For this timing diagram, the output of the Clock Delay Latch 206 is Q₀=0, Q₁=0, Q₂=0, Q₃=1, Q₄=1, Q₅=1, Q₆=1, Q₇=0, Q₈=0. For this value, the optimum Data Delay Circuit 208 output selection would be Q₃. The multiplexer 210 logic would select D₃ and apply it to the Y output as shown in the MUX Y line on the timing diagram. The delayed data from the multiplexer 210 is applied to the D input of the D Latch 212. The re-timed data output is shown as OUTPUT on the timing output.

For the example shown in FIG. 9, the following table 1 shows the relationship between all the possible values from the Clock Delay Circuit 204 to the Mux Y output.

TABLE 1
Mux Control Logic

| Clock Delay Latch Output (2) Bits | | | | | | | | | |
|---|---|---|---|---|---|---|---|---|---|
| 8 | 7 | 6 | 5 | 4 | 3 | 2 | 1 | 0 | Y Output |
| 1 | 0 | 0 | 0 | 0 | 1 | 1 | 1 | 1 | Q₀ |
| 0 | 0 | 0 | 0 | 1 | 1 | 1 | 1 | 0 | Q₁ |
| 0 | 0 | 0 | 1 | 1 | 1 | 1 | 0 | 0 | Q₂ |
| 0 | 0 | 1 | 1 | 1 | 1 | 0 | 0 | 0 | Q₃ |
| 0 | 1 | 1 | 1 | 1 | 0 | 0 | 0 | 0 | Q₄ |
| 1 | 1 | 1 | 1 | 0 | 0 | 0 | 0 | 1 | Q₅ |
| 1 | 1 | 1 | 0 | 0 | 0 | 0 | 1 | 1 | Q₆ |
| 1 | 1 | 0 | 0 | 0 | 0 | 1 | 1 | 1 | Q₇ |
| 1 | 0 | 0 | 0 | 0 | 1 | 1 | 1 | 1 | Q₈ |

This table shows the possible conditions for the example of FIG. 9. A specific implementation may have to allow for additional test cases, or be adjusted to compensate for actual delays within the implementation. For example, the selected Y output may be adjusted to compensate for the delay in the multiplexer 210.

The design illustrated in FIGS. 6 and 9 employs a positive transition on the data input to determine the correct multiplexer output to use. The circuit can also be designed to operate on the negative transition of the data input. From analyzing the timing diagram in FIG. 9, it can be seen that the output of the Clock Delay Latch 206 is the same. This approach may be adopted for RZL data types.

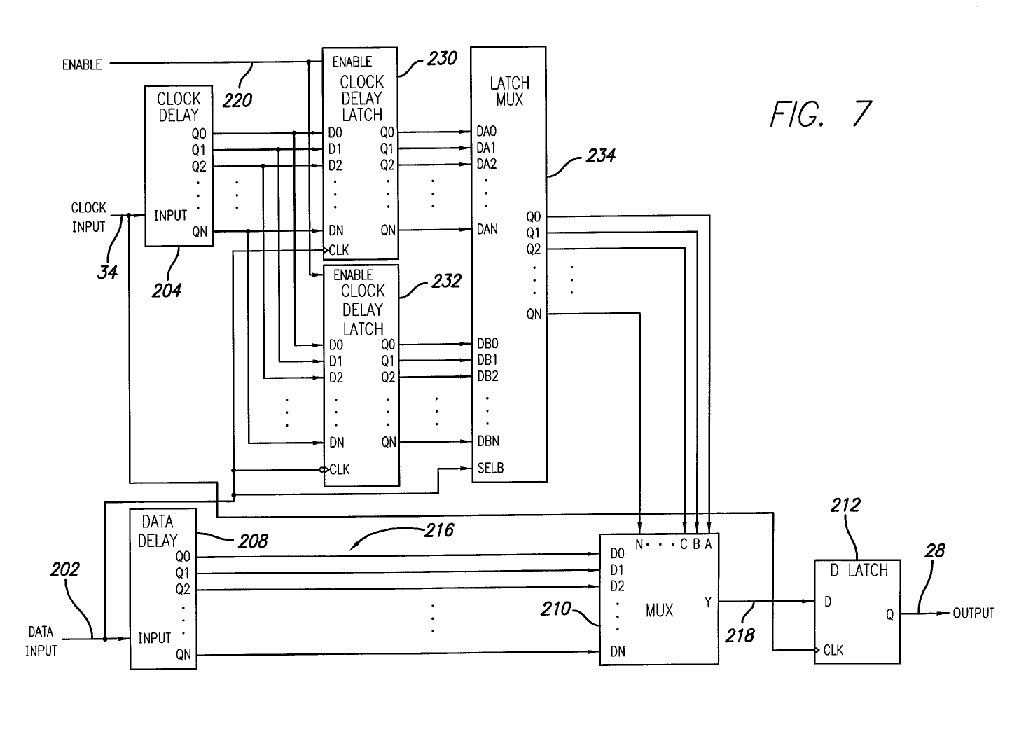

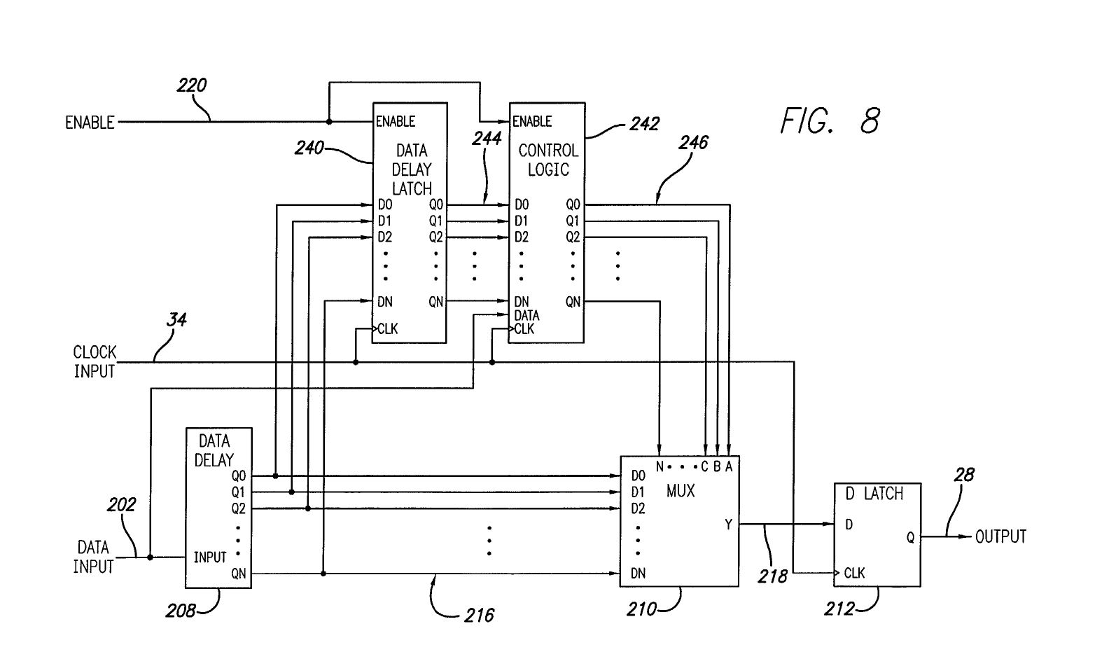

Referring to FIG. 7 an alternate embodiment of the back end 132 is illustrated. In the embodiment of FIG. 7 the circuit latches the Clock Delay Circuit 204 output on both the positive and negative edge of the data. To provide this capability a positive Clock Delay Latch 230 and a negative Clock Delay Latch 232 are employed, both of which are coupled to the output of the Clock Delay Circuit 204. The output of the positive Clock Delay Latch 230 and the negative Clock Delay Latch 232 are connected to the Latch Multiplexer (MUX) 234. The Latch Multiplexer 234 selects which Clock Delay Latch output, i.e., the Clock Delay Latch 230 or 232 output, to use based on the polarity of the data input. The rest of the circuit is the same as the embodiment of FIG. 6 and like numerals are employed. Accordingly, the operation of the embodiment of FIG. 7 will be appreciated from the previously described embodiment and need not be described further.

Referring to FIG. 8 another alternate embodiment of the optical receiver back end 132 is illustrated. This embodiment has the advantage of operating on either data edge and may operate with only one delay logic section.

The embodiment shown in FIG. 8 contains several circuit blocks similar to the other embodiments and like numerals are employed for corresponding circuit elements. Specifically, the embodiment shown in FIG. 8 contains Data Delay Circuit 208, Multiplexer 210 and D Latch 212 which generally correspond to the corresponding circuits described previously. Data Delay Latch 240 and Control Logic 242 are added to the embodiment of FIG. 8. The circuit is designed to phase align the Data Input to the Clock Input by selecting the correct Data Delay Circuit 208 output so that the D input to the D Latch 212 is 180 degrees out of phase with the Clock Input. In FIG. 8 the D input to the Mux 210 is connected to the Data Delay Q outputs using path 216. The Mux 210 inputs may optionally be connected to the Data Delay Latch Q outputs at path 244 instead.

The Data Delay Circuit 208 receives the Data Input along line 202 and delays the Data Input by n+1 steps. There must be a minimum of 4 steps. The steps preferably have equal spacing with each step equal to (clock period)/n. More steps provide better phase resolution. For example, 4 steps provide phase steps at 120, 240, 360 and 480 degrees referenced to the Clock Input and the maximum phase error would be 60 degrees. For 9 steps, the phase steps would be 45, 90, 135, 180, 225, 270, 315, 360, and 405 and the maximum phase error would be 45 degrees. More steps may be provided and may be desirable to reduce phase error and improve jitter performance. The Data Delay Latch 240 receives the delayed data and latches the output of the Data Delay Circuit 208 on the rising edge of the Clock Input.

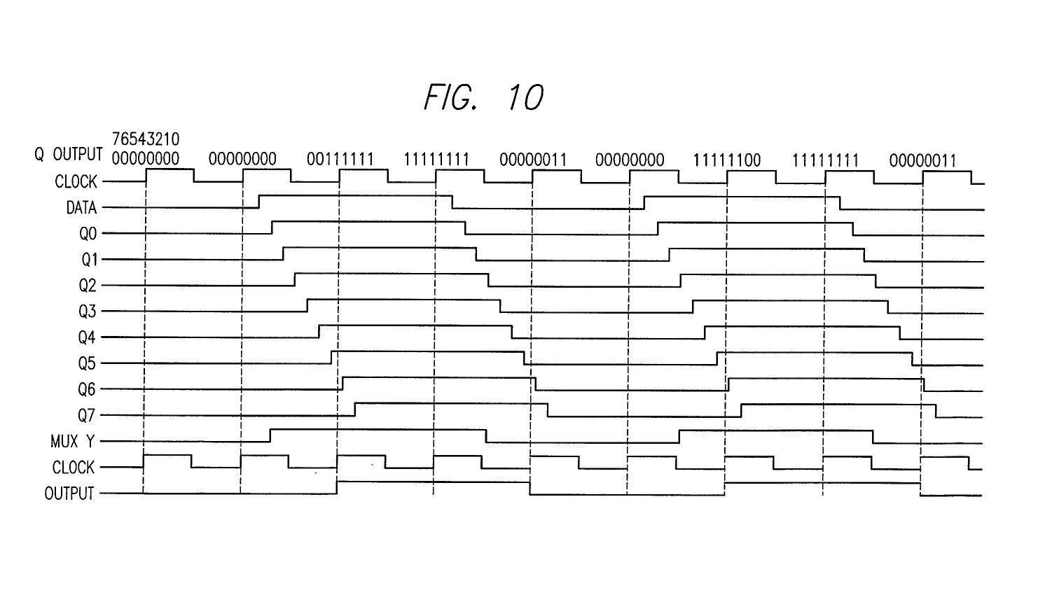

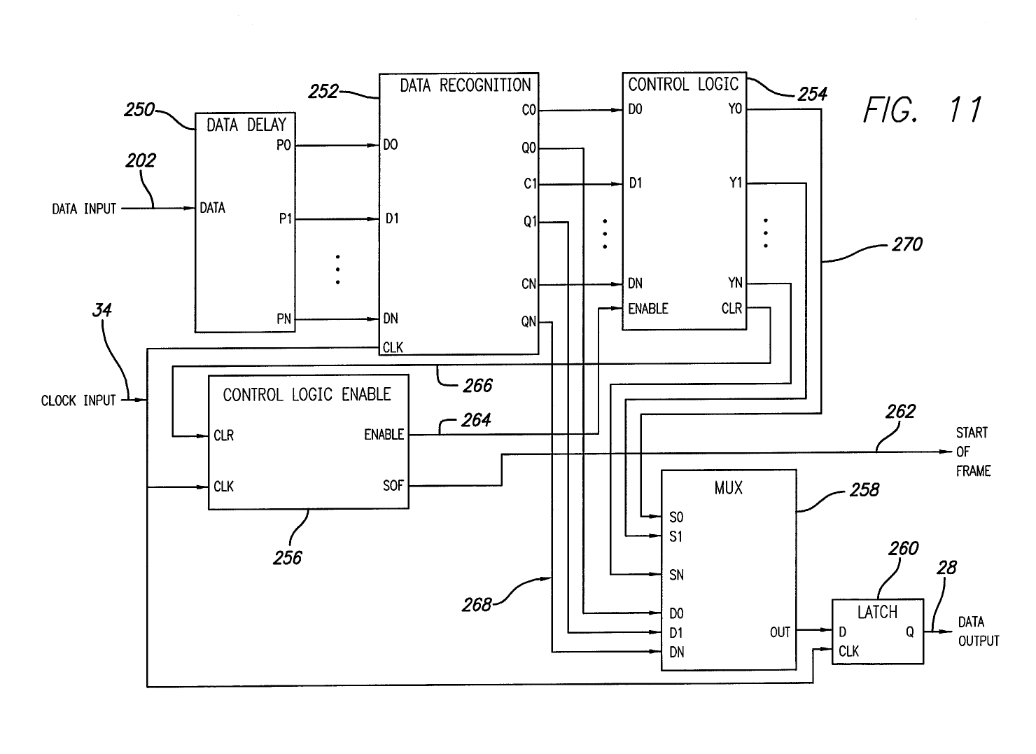

The timing diagram of FIG. 10 illustrates the operation of the Data Delay Latch 240 and the Data Delay Circuit 208 of FIG. 8. The timing diagram of FIG. 8 shows a Data Delay Circuit 208 output with 8 stages (n=7). For this example, the Data Delay Latch 240 can only have the values shown below.

TABLE 2
Data Latch Output

| Value | Meaning |
|---|---|
| 00000000 | Data was always low at the rising edge of the clock. No action |
| | is taken. |
| 00000001 | The rising data edge occurred between 51 and 103 degrees |
| | referenced to the rising clock edge. |
| 00000011 | The rising data edge occurred between 103 and 154 degrees |
| | referenced to the rising clock edge. |
| 00000111 | The rising data edge occurred between 154 and 206 degrees |
| | referenced to the rising clock edge. |
| 00001111 | The rising data edge occurred between 206 and 257 degrees |
| | referenced to the rising clock edge. |
| 00011111 | The rising data edge occurred between 257 and 309 degrees |
| | referenced to the rising clock edge. |
| 00111111 | The rising data edge occurred between 309 and 360 degrees |
| | referenced to the rising clock edge. |
| 01111111 | The rising data edge occurred between 360 and 411 degrees |
| | referenced to the rising clock edge. |
| 11111111 | Data was always high at the rising edge of the clock. No |
| | action is taken. |
| 11111110 | The falling data edge occurred between 51 and 103 degrees |
| | referenced to the rising clock edge. |
| 11111100 | The falling data edge occurred between 103 and 154 degrees |
| | referenced to the rising clock edge. |
| 11111000 | The falling data edge occurred between 154 and 206 degrees |
| | referenced to the rising clock edge. |
| 11110000 | The falling data edge occurred between 206 and 257 degrees |
| | referenced to the rising clock edge. |
| 11100000 | The falling data edge occurred between 257 and 309 degrees |
| | referenced to the rising clock edge. |
| 11000000 | The falling data edge occurred between 309 and 360 degrees |
| | referenced to the rising clock edge. |
| 10000000 | The falling data edge occurred between 360 and 411 degrees |
| | referenced to the rising clock edge. |

Due to metastability problems common with latches, other table values may be present which cause more decisions points. For example, a pattern of 11110100 may be recorded which would be folded to the 11110000 test case.

The enable input on line 220 stores the last value and keeps the Data Delay Latch 240 from updating. This is useful if the system determines operation during the preamble of a data stream and wants to maintain the system during the data portion.

The Control Logic 242 determines the selection value for the Multiplexer 210 and is based on the output from the Data Delay Latch 240. The action occurs on the rising edge of the Clock Input. For example, operation for n=7 is shown in the following table.

TABLE 3
Control Logic Output

| Input | Output | |
|---|---|---|
| Value | Value | Meaning |
| 00000000 | Q | No change to output. |
| 00000001 | Q4 | Q4 high all other Qs low. |
| 00000011 | Q5 | Q5 high all other Qs low. |
| 00000111 | Q6 | Q6 high all other Qs low. |
| 00001111 | Q0 | Q0 high all other Qs low. |
| 00011111 | Q1 | Q1 high all other Qs low. |
| 00111111 | Q2 | Q2 high all other Qs low. |
| 01111111 | Q3 | Q3 high all other Qs low. |
| 11111111 | Q | No change to output. |
| 11111110 | Q4 | Q4 high all other Qs low. |
| 11111100 | Q5 | Q5 high all other Qs low. |
| 11111000 | Q6 | Q6 high all other Qs low. |
| 11110000 | Q0 | Q0 high all other Qs low. |
| 11100000 | Q1 | Q1 high all other Qs low. |
| 11000000 | Q2 | Q2 high all other Qs low. |
| 10000000 | Q3 | Q3 high all other Qs low. |

Due to metastability problems common with latches, other table values may be present which causes more decision points. For example, a pattern of 11110100 may be recorded which would be folded to the 11110000 test case causing a Q0 decision. The Control Logic 242 must provide only one valid output so as not to confuse the Multiplexer 210.

The Multiplexer (MUX) 210 selects the output from the Data Delay Circuit 208 to connect to its Y output. This selection is made by the control inputs A . . . N provided from control logic 242 along lines 246. For example, Multiplexer 210 operation is described in the following table.

TABLE 4
Mux Logic

| Input | | |
|---|---|---|
| Value | Output | |
| 6543210 | Value | Meaning |
| 0000001 | D0 | D0 connected to Y output. |
| 0000010 | D1 | D1 connected to Y output. |
| 0000100 | D2 | D2 connected to Y output. |
| 0001000 | D3 | D3 connected to Y output. |
| 0010000 | D4 | D4 connected to Y output. |
| 0100000 | D5 | D5 connected to Y output. |
| 1000000 | D6 | D6 connected to Y output. |

In the above table it is assumed the Control Logic 242 will only provide one valid output used as an input to the Multiplexer 210. However, the selected output may differ to compensate for circuit delays.

The D Latch 212 synchronizes the selected phase shifted Data Input provided by the Multiplexer 210 to the Clock Input as discussed above in relation to the previous embodiment and outputs the aligned data on line 28.

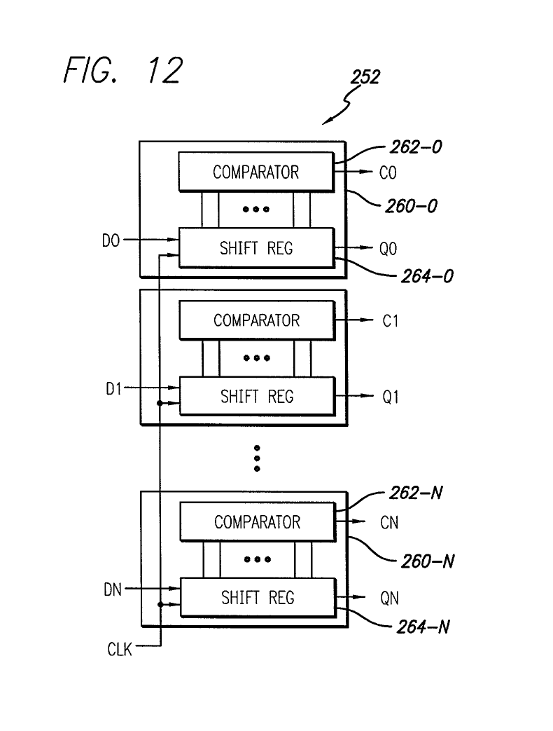

FIG. 11 is a block schematic drawing of an optical receiver back end employing a data recognition circuit for clock and data phase alignment in accordance with an alternate embodiment of the present invention. The embodiment of FIG. 11 may be employed where a known data pattern is present in the received data, for example, in a preamble field or header in a data packet format employed in burst transmission. The embodiment of FIG. 11 has the advantage that it also detects the beginning of a packet and the phase relationship of the clock and data may be fixed for the remainder of the packet.

Referring to FIG. 11, the Data Input along line 202 is provided to Data Delay Circuit 250. Data Delay Circuit 250 delays the data by 4 or more discrete steps. The number of steps should preferably be equally spaced comprising N+1 steps, with each step equal to clock period/N. The spacing of the delay does not need to be continuously spaced but must be homogenous meaning that delay N must be less than delay N+1. Larger values of N provide greater resolution with finer selection at the expense of more logic.

The delayed data is provided from the Data Delay Circuit 250 to Data Recognition Circuit 252. This will be described in more detail below in relation to FIG. 12; the Data Recognition Circuit 252 contains N+1 shift registers and comparators, one for each delay tap in the Data Delay Circuit 250. Each shift register/comparator has 2 outputs. One is the shifted data and the other is the compare result. The comparator compares the parallel output from the shift register to the fixed data pattern or preamble. The shifted data is output to Multiplexer 258 while the comparator outputs are provided to Control Logic 254.

The Control Logic 254 determines which data stream originated from the Data Delay Circuit 250 as processed by the Data Recognition 252 to use for the output data based on the comparator outputs from the Data Recognition Circuit 252. More specifically, Control Logic 254 looks at the compare outputs (CO, C1, . . . CN) from the Data Recognition circuit 252 to determine the correct data stream to use by setting one of the Y1, Y2, . . . YN outputs. The Control Logic 254 only starts the process when enabled by the Control Logic Enable Circuit 256 through the Enable control line 264. Finally once the Control Logic 254 determines the correct data stream to use, it resets the Control Logic Enable Circuit 256 using the CLR output along line 266. The following table illustrates the behavior of the Control Logic 254 using N=3.

TABLE 5

| C0 | C1 | C2 | C3 | ENABLE | Result |
|---|---|---|---|---|---|
| 0 | 0 | 0 | 0 | X | No Selection |
| 0 | 1 | 1 | 1 | 0 | No Selection as ENABLE is low |
| 0 | 1 | 1 | 1 | 1 | Use Y2 as it is closest to the center. |
| 0 | 1 | 0 | 0 | 1 | No Selection as system must have at least |
| | | | | | 2 consecutive valid. |
| 0 | 1 | 0 | 1 | 1 | No Selection as system must have at least |
| | | | | | 2 consecutive valid. |
| 1 | 1 | 1 | 0 | 1 | Use Y1 as it is closest to the center. |
| 1 | 1 | 0 | 1 | 1 | Use Y0 as C3 is in the next bit period |
| 1 | 0 | 1 | 1 | 1 | Use Y3 as C0 is in the previous bit period |
| 1 | 1 | 1 | 1 | 1 | No selection as the data all are valid. |

For Table 5, a 1 represents a valid pattern was detected from the Data Recognition Circuit 252 and a 0 represents a non-valid pattern was detected. The system must have at least 2 consecutive valid patterns and at least one that is not valid to make a selection. The table values may be different for other implementations or other timing considerations.

The Control Logic Enable Circuit 256 enables the Control Logic 254 to change settings only at the start of a data packet. The phase then remains fixed for the remainder of the packet. The Control Logic Enable Circuit 256 detects the start of a data packet or data frame within a packet. The Control Logic Enable Circuit 256 can work in one of two modes depending on the data packet structure. The first mode is used for fixed packet length without a unique but fixed start of packet (header). For example, ATP protocols used in PON fiber optic networks may have a suitable packet format. The second mode is used when a unique, fixed header is available. The second mode may be used with packets of varying length. For example, TCIP or Ethernet protocols may have such a variable packet length structure.

For fixed packet lengths, a counter within the Control Logic Enable Circuit 256 counts the clock (which is the bit rate for the data in the packet). When the counter reaches the number of bits in the packet, it sets the ENABLE output high along line 264 and pulses the start of frame (SOF) output on line 262. The ENABLE output stays high until the Control Logic 254 determines a new setting. At that time, the Control Logic 254 sets the CLR output high which then resets the counter and allows it to count to the next start of packet. This system may require several packets before it locks to the start of the packet. Lock will occur whenever a period of time expires equal to or greater than the packet length without containing the fixed header. The SOF signal is also output along line 262 from the Control Logic Enable Circuit 256.

For variable packet lengths, the data must contain a unique, fixed header. The comparators within the Data Recognition Circuit 252 would be set to recognize the header and the Control Logic Enable Circuit 256 would not be required and the ENABLE input to the Control Logic 254 would be set high.

The circuit of FIG. 11 may also be designed without the Control Logic Enable Circuit 256 in applications where it is not necessary to maintain the phase relationship fixed throughout a data packet. For this mode, the ENABLE input to the Control Logic 254 would be set high and a new output from the Data Recognition Circuit 252 would be selected whenever the pattern is recognized.

The Multiplexer 258 selects which data stream to use from the Data Recognition Circuit 252 logic based on the output of the Control Logic 254 provided along line 270. The Multiplexer 258 selects which output (Q0, Q1, . . . Qn) is used from the Data Recognition Circuit 252 based on the selection input (S0, S1, . . . SN) from the Control Logic 254. Only one S0, S1, . . . SN is allowed to be high at any time. The OUT output from the Multiplexer 258 contains the selected data.

The Latch 260 synchronizes the data from the Multiplexer 258 OUT with the Clock Input and provides the synchronized output as the Data Output on line 28.

A preferred embodiment of the Data Recognition Circuit 252 of the embodiment of FIG. 11 is shown in FIG. 12.

Referring to FIG. 12, the Data Recognition Circuit 252 receives the various delayed data D0-DN provided from Data Delay Circuit 250 and shifts the delayed data into N+1 comparison stages 260-0 -260-N. Each comparison stage 260 includes a comparator 262 and a shift register 264. The Data Recognition Circuit 252 thus contains as many shift registers and comparators as there are outputs from the Data Delay Circuit 250. Each shift register contains at least the number of bits as required for the recognition pattern. The more bits used, the better the results. For example, if the compare pattern is 8 bits, then each shift register is 8 bits long and the comparator is 8 bits wide. Each shift register is clocked by the clock input as illustrated. The parallel output of each of the shift registers 264 is compared to the fixed data pattern by comparators 262. The parallel output from the shift register drives one set of inputs (A inputs) to the comparator. The other set of inputs to the comparator (B inputs) are the same for each comparator and contain the fixed data pattern. The source of the B inputs (not shown in FIG. 12) may be any suitable memory storing the reference pattern, which memory may preferably be a writable memory which may be accessed by the user to alter the pattern for the particular application. The comparator output C for each comparator is valid when A=B. Outputs C0-CN are generated each time a compare is generated. From the compare outputs, the system determines which of the delayed data streams to output as described above in relation to FIG. 11.

The above described embodiments of the clock and data phase aligner circuit of the present invention provide a number of advantageous features including high speed phase locking, the ability to remember phase relationship and maintain using the enable control, and the ability to operate from DC to GHz range, limited only by logic speed. Additional advantageous features will be apparent to those skilled in the art.

In view of the foregoing detailed description of preferred embodiments of the present invention, it will be appreciated that the present invention provides an optical receiver and/or transceiver adapted for use in an optical fiber data transmission system which is capable of efficiently detecting burst mode data transmission from multiple transmitters despite phase differences between data bursts. The present invention further provides an optical receiver or transceiver which can provide such efficient data detection without added cost or complexity. The present invention further provides an optical receiver or transceiver capable of operating in both burst and continuous mode.

Although the present invention has been described in relation to specific embodiments it should be appreciated that the present invention is not limited to these specific embodiments as a number of variations are possible while remaining within the scope of the present invention. In particular, the specific circuit implementations illustrated are purely exemplary and may be varied in ways too numerous to enumerate in detail. Accordingly they should not be viewed as limiting in nature.

What is claimed is:

1. An optical receiver, comprising:
a photo-detector for receiving an input modulated light beam and providing as an output a modulated electrical signal;
a front end coupled to the photo-detector output and providing a digital signal; and
a back end coupled to the front end and receiving the digital signal and a clock signal and providing a phase aligned signal derived from the digital signal, the back end comprising a clock and data phase aligning circuit, the clock and data phase aligning circuit comprising a data delay circuit receiving the digital signal and delaying the digital signal to provide plural phase shifted digital signals from said digital signal and a selection circuit selecting one of said plural phase shifted digital signals as the phase aligned signal.

2. An optical receiver as set out in claim 1, wherein said clock and data phase aligning circuit further comprises a clock delay circuit receiving the clock signal and delaying the clock signal to provide plural delayed clock signals.

3. An optical receiver as set out in claim 2, wherein said selection circuit comprises a multiplexer coupled to the clock delay circuit and the data delay circuit.

4. An optical receiver as set out in claim 2, wherein said clock and data phase aligning circuit further comprises a clock delay latch coupled to the clock delay circuit and receiving the plural delayed clock signals and the digital signal, the clock delay latch latching the plural delayed clock signals in response to the digital signal.

5. An optical receiver as set out in claim 3, wherein said clock and data phase aligning circuit further comprises a data latch receiving the clock signal and receiving and outputting the selected digital signal in response to the clock signal.

6. An optical receiver as set out in claim 4, wherein the clock delay latch latches the plural delayed clock signals in response to the rising edge of the digital signal.

7. An optical receiver as set out in claim 1, wherein said clock and data phase aligning circuit further comprises a first clock delay latch and a second clock delay latch, coupled to the clock delay circuit and receiving the plural delayed clock signals and the digital signal, the first and second clock delay latches latching the plural delayed clock signals in response to the rising and falling edge of the digital signal, respectively.

8. An optical receiver as set out in claim 7, wherein said clock and data phase aligning circuit further comprises a latch multiplexer coupled to the first clock delay latch and the second clock delay latch and receiving the digital signal, for selecting the output of the first clock delay latch or the second clock delay latch based on the polarity of the digital signal.

9. An optical receiver as set out in claim 1, wherein said clock and data phase aligning circuit further comprises a data delay latch receiving the plural phase shifted digital signals and the clock signal and latching the phase shifted digital signals in response to the clock signal and a control logic circuit coupled to the output of the data delay latch and providing a control signal to the selection circuit based on the data delay latch output.

10. An optical receiver as set out in claim 9, wherein said data delay latch further comprises an enable input for maintaining a latched data in response to an enable signal.

11. An optical receiver, comprising:
a photo-detector for receiving an input modulated light beam and providing as an output a modulated electrical signal;
a front end coupled to the photo-detector output and providing a digital signal; and
a back end coupled to the front end and receiving the digital signal and a clock signal and outputting a phase aligned signal derived from the digital signal, the back end comprising:
a data delay circuit receiving the digital signal and delaying the digital signal to provide plural delayed digital signals from said digital signal;
a data recognition circuit for comparing the plural delayed digital signals to a reference data pattern and providing plural comparison signals;
a control logic circuit coupled to the data recognition circuit for providing a control signal based on the plural comparison signals; and
a selection circuit selecting one of said plural delayed digital signals in response to said control signal.

12. An optical receiver as set out in claim 11, wherein said data recognition circuit comprises and a plurality of shift registers, the shift registers receiving the plurality of delayed digital signals and a plurality of comparators comparing the shift register outputs to the reference data pattern.

13. An optical receiver as set out in claim 11, further comprising a control logic enable circuit for enabling the control logic circuit at the beginning of a data packet.

14. An optical receiver as set out in claim 11, wherein said selection circuit comprises a multiplexer coupled to the control logic circuit and the data recognition circuit.

15. An optical receiver as set out in claim 11, wherein the back end further comprises a data latch receiving the clock signal and receiving and outputting the selected delayed digital signal in response to the clock signal.

16. An optical transceiver, comprising:
a transmitter comprising a laser diode providing modulated optical signals and a laser driver coupled to a data input and providing a drive signal to the laser diode corresponding to the input data; and
a receiver comprising a front end coupled to receive input modulated light from an optical fiber and providing a corresponding digital electrical signal and a back end coupled to receive the digital electrical signal and provide output clock aligned data signals, the back end comprising a clock and data phase aligning circuit, the clock and data phase aligning circuit comprising a data delay circuit receiving the digital signal and delaying the digital signal to provide plural phase shifted digital signals from said digital signal and a selection circuit selecting one of said plural phase shifted digital signals as the phase aligned output.

17. A burst mode optical data transmission system, comprising:
a plurality of transmitters providing burst mode modulated optical signals;
at least one optical fiber optically coupled to the transmitters; and
a receiver optically coupled to the fiber and receiving the burst mode modulated optical signals, the receiver comprising:
means for receiving the modulated light from the optical fiber at the receive location;
means for converting the received modulated light to a digital electrical signal;
means for aligning the phase of the digital signal to the phase of a clock signal on a burst to burst basis; and
means for providing a clock aligned digital signal as an output.

18. A method for transmitting data between transmit and receive locations over an optical network in a burst mode, comprising:
providing modulated light to an optical fiber at the transmit location in bursts, the bursts comprising a plurality of data bits;
receiving the modulated light from the optical fiber at the receive location;
converting the received modulated light to a digital electrical signal;
aligning the phase of the digital signal to the phase of a clock signal on a burst to burst basis; and
providing the clock aligned digital signal as an output.
